(19) United States
(12) Patent Application Publication
(10) Pub. No.: US 2019/0167066 A1
(43) Pub. Date: Jun. 6, 2019

(54) DISHWASHER APPLIANCE HAVING A PRESSURE SENSOR AND A TUB LIP SENSOR FOR FLOOD DETECTION

(71) Applicant: Haier US Appliance Solutions, Inc., Wilmington, DE (US)

(72) Inventor: Kyle Edward Durham, Louisville, KY (US)

(21) Appl. No.: 15/832,849

(22) Filed: Dec. 6, 2017

(51) Int. Cl. A47L 15/42; G05D 7/06; G05B 15/02

(52) U.S. Cl. CPC A47L 15/421; G05D 7/0688; A47L 2501/26; A47L 2401/09; A47L 2501/02; G05B 15/02

(57) ABSTRACT

A dishwasher appliance that includes features that allow for prevention and detection of flood events or tub overfills without sacrificing performance or efficiency of the dishwasher appliance is provided. Moreover, methods for detecting and preventing such flood events are also provided.

### FIELD OF THE INVENTION

The present disclosure relates generally to dishwasher appliances, and more particularly to dishwasher appliances having flood detection and prevention features and methods therefore.

### BACKGROUND OF THE INVENTION

Dishwasher appliances generally include a tub that defines a wash chamber. Rack assemblies can be mounted within the wash chamber of the tub for receipt of articles for washing. Multiple spray assemblies can be positioned within the wash chamber for applying or directing wash fluid towards articles disposed within the rack assemblies in order to clean such articles. Dishwasher appliances are also typically equipped with at least one circulation pump for circulating fluid through the multiple spray assemblies.

Under certain conditions, dishwasher appliances are prone to flooding over a tub lip of the tub. For instance, dishwasher appliances may be prone to flooding over the tub lip during an out-of-level condition, an inlet water valve failure, and/or a drain pump failure. When one or more of such conditions occur, the water level can rise above the designed fill level and spill over the tub lip and onto the floor. This may be detrimental to consumers' homes.

Certain dishwasher appliances include features for detecting tub overfills or flood events. For example, some conventional dishwasher appliances include float sensors. To detect a flood event, the float sensor floats on top of the water in the tub, and if the float sensors floats upward to a certain height, the float sensor triggers a response indicating a flood event. One challenge with float sensors is that they are typically located proximate the sump area of the tub, and accordingly, such float sensors affect the water flow through the sump area during wash and drain cycles. This may decrease the efficiency and performance of the dishwasher appliance during normal operating conditions. Moreover, some conventional float sensors are located in the manual filter chamber where soiled water collects during a wash cycle. By locating the float sensor in the manual filter chamber, the volume of soiled water that can be collected is limited, which may negatively affect wash performance. Further, other conventional dishwasher appliances include pressure sensors that activate when the water level is excessively high. However, such pressure sensors can be prone to nuisance or inadvertent tripping and typically allow for little time for the dishwasher appliance to take corrective action to prevent a flood event.

Accordingly, dishwasher appliances that include flood prevention features and methods therefore that address one or more of the challenges noted above would be useful.

### BRIEF DESCRIPTION OF THE INVENTION

The present disclosure provides a dishwasher appliance that includes features that allow for prevention and detection of flood events or tub overfills without sacrificing performance or efficiency of the dishwasher appliance. Moreover, methods for detecting and preventing such flood events are also provided. Additional aspects and advantages of the invention will be set forth in part in the following description, may be apparent from the description, or may be learned through practice of the invention.

In accordance with one exemplary embodiment, a method for detecting a flood event in a dishwasher appliance is provided. The dishwasher appliance includes a cabinet and a tub positioned within the cabinet. The tub has a tub lip. The dishwasher appliance also includes a pressure sensor, a tub lip sensor, a drain pump, and a circulation pump. The method includes determining whether the circulation pump is activated. The method also includes determining whether a pressure sensor output of the pressure sensor is greater than or equal to a first pressure threshold for a predetermined time if the circulation pump is not activated, or, determining whether the pressure sensor output of the pressure sensor is greater than or equal to a second pressure threshold for a predetermined time if the circulation pump is activated. Further, the method includes determining whether the tub lip sensor has sensed wash fluid at or proximate the tub lip for a predetermined time if the pressure sensor output is not greater than or equal to either the first pressure threshold for the predetermined time or the second pressure threshold for the predetermined time. In addition, the method includes activating the drain pump if the tub lip sensor has sensed wash fluid at or proximate the tub lip for the predetermined time.

In accordance with another exemplary embodiment, a dishwasher appliance is provided. The dishwasher appliance includes a cabinet and a tub positioned within the cabinet. The tub defines a wash chamber for receipt of articles for washing. The tub includes a tub lip. The dishwasher appliance also includes a tub lip sensor positioned proximate the tub lip. The dishwasher appliance further includes one or more spray assemblies and a circulation pump for circulating wash fluid to the one or more spray arm assemblies. In addition, the dishwasher appliance includes a drain pump, a sump, and a pressure sensor mounted to the sump. Moreover, the dishwasher appliance includes a controller communicatively coupled with the pressure sensor, the tub lip sensor, the drain pump, and the circulation pump. The controller is configured to: determine whether the circulation pump is activated; determine whether a pressure sensor output of the pressure sensor is greater than or equal to a first pressure threshold for a predetermined time if the circulation pump is not activated, or, determine whether the pressure sensor output of the pressure sensor is greater than or equal to a second pressure threshold for a predetermined time if the circulation pump is activated; determine whether the tub lip sensor has sensed wash fluid at or proximate the tub lip for a predetermined time if the pressure sensor output is not greater than or equal to either the first pressure threshold for the predetermined time or the second pressure threshold for the predetermined time; and activate the drain pump if the controller determines that the tub lip sensor has sensed wash fluid at or proximate the tub lip for the predetermined time.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an exemplary embodiment of a dishwasher appliance of the present disclosure with a door in a partially open position;

FIG. 2 provides a side, cross sectional view of the exemplary dishwasher appliance of FIG. 1;

FIG. 3 provides a close up, cross sectional view of a sump and a pressure sensor of the dishwasher appliance of FIGS. 1 and 2;

FIG. 4 provides a perspective view of an exemplary tub lip sensor coupled with a tub lip of a tub of the dishwasher appliance of FIGS. 1 and 2; and

FIGS. 5A and 5B provide a flow diagram of an exemplary method for detecting a flood event according to exemplary embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “article” may refer to, but need not be limited to dishes, pots, pans, silverware, and other cooking utensils and items that can be cleaned in a dishwashing appliance. The term “wash cycle” is intended to refer to one or more periods of time during which a dishwashing appliance operates while containing the articles to be washed and uses a detergent and water, preferably with agitation, to e.g., remove soil particles including food and other undesirable elements from the articles. The term “rinse cycle” is intended to refer to one or more periods of time during which the dishwashing appliance operates to remove residual soil, detergents, and other undesirable elements that were retained by the articles after completion of the wash cycle. The term “drain cycle” is intended to refer to one or more periods of time during which the dishwashing appliance operates to discharge soiled water from the dishwashing appliance. The term “wash fluid” refers to a liquid used for washing and/or rinsing the articles and is typically made up of water that may include other additives such as detergent or other treatments. Furthermore, as used herein, terms of approximation, such as “approximately,” “substantially,” or “about,” refer to being within a ten percent (10%) margin of error.

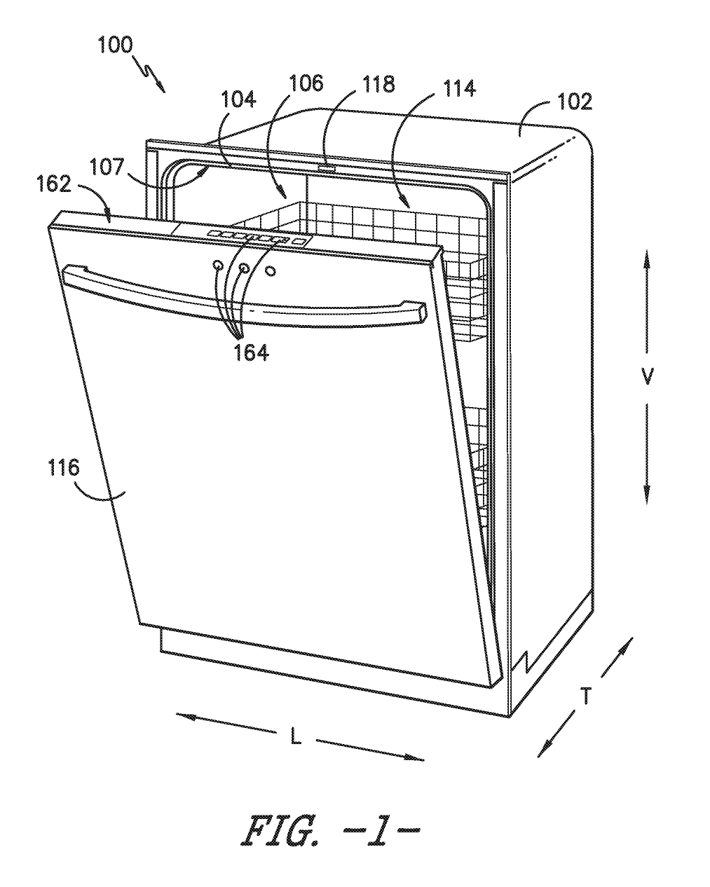

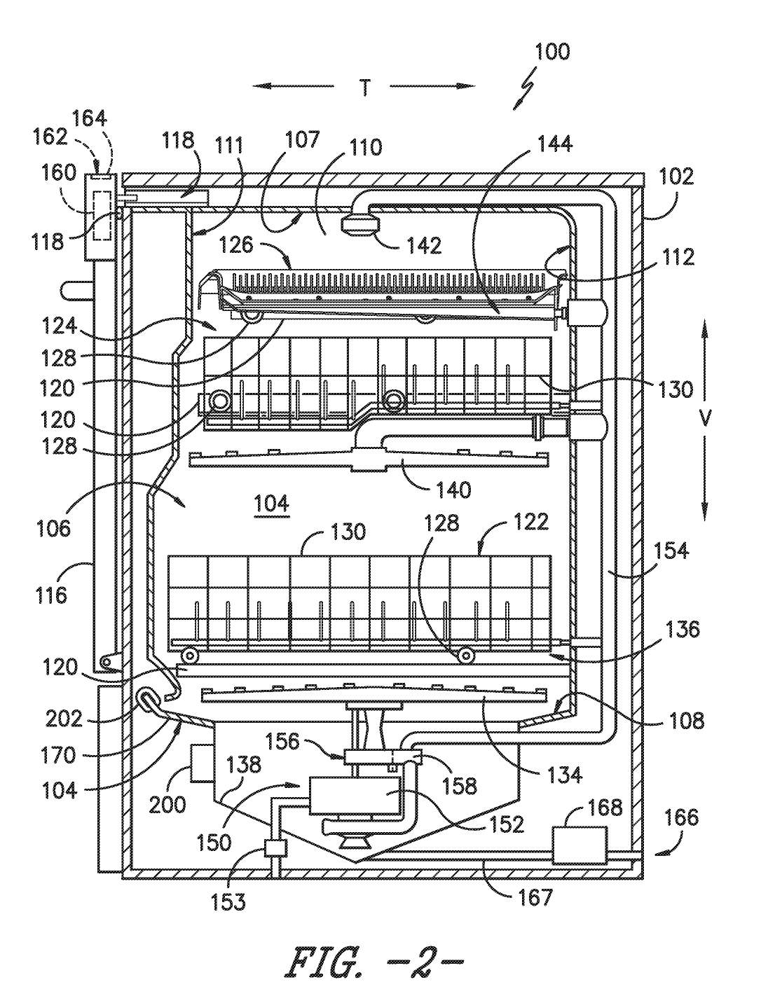

FIGS. 1 and 2 depict an exemplary dishwasher or dishwashing appliance 100 that may be configured in accordance with aspects of the present disclosure. For the particular embodiment of FIGS. 1 and 2, dishwasher 100 defines a vertical direction V, a lateral direction L, and a transverse direction T. Each of the vertical direction V, lateral direction L, and transverse direction T are mutually perpendicular to one another and form an orthogonal direction system. Dishwasher 100 includes a cabinet 102 having a tub 104 therein that defines a wash chamber 106. As shown in FIG. 2, tub 104 extends between a top 107 and a bottom 108 along the vertical direction V, between a pair of side walls 110 along the lateral direction L, and between a front side 111 and a rear side 112 along the transverse direction T.

Tub 104 includes a front opening 114 (FIG. 1) and a door 116 hinged at its bottom for movement between a normally closed vertical position (shown in FIG. 2), wherein the wash chamber 106 is sealed shut for washing operation, and a horizontal open position for loading and unloading of articles from the dishwasher 100. Dishwasher 100 includes a door closure mechanism or assembly 118 that is used to lock and unlock door 116 for accessing and sealing wash chamber 106.

As further shown in FIG. 2, tub side walls 110 accommodate a plurality of rack assemblies. More specifically, guide rails 120 are mounted to side walls 110 for supporting a lower rack assembly 122, a middle rack assembly 124, and an upper rack assembly 126. Upper rack assembly 126 is positioned at a top portion of wash chamber 106 above middle rack assembly 124, which is positioned above lower rack assembly 122 along the vertical direction V. Each rack assembly 122, 124, 126 is adapted for movement between an extended loading position (not shown) in which the rack is substantially positioned outside the wash chamber 106, and a retracted position (shown in FIGS. 1 and 2) in which the rack is located inside the wash chamber 106. This is facilitated, for example, by rollers 128 mounted onto rack assemblies 122, 124, 126, respectively. Although guide rails 120 and rollers 128 are illustrated herein as facilitating movement of the respective rack assemblies 122, 124, 126, it should be appreciated that any suitable sliding mechanism or member may be used according to alternative embodiments.

Some or all of the rack assemblies 122, 124, 126 are fabricated into lattice structures including a plurality of wires or elongated members 130 (for clarity of illustration, not all elongated members making up rack assemblies 122, 124, 126 are shown in FIG. 2). In this regard, rack assemblies 122, 124, 126 are generally configured for supporting articles within wash chamber 106 while allowing a flow of wash fluid to reach and impinge on those articles, e.g., during a cleaning or rinsing cycle. According to other exemplary embodiments, a silverware basket (not shown) may be removably attached to a rack assembly, e.g., lower rack assembly 122, for placement of silverware, utensils, and the like, that are otherwise too small to be accommodated by rack 122.

Dishwasher 100 further includes a plurality of spray assemblies for urging a flow of water or wash fluid onto the articles placed within wash chamber 106. More specifically, as illustrated in FIG. 2, dishwasher 100 includes a lower spray arm assembly 134 disposed in a lower region 136 of wash chamber 106 and above a sump 138 so as to rotate in relatively close proximity to lower rack assembly 122. Similarly, a mid-level spray arm assembly 140 is located in an upper region of wash chamber 106 and may be located below and in close proximity to middle rack assembly 124. In this regard, mid-level spray arm assembly 140 is generally configured for urging a flow of wash fluid up through middle rack assembly 124 and upper rack assembly 126. Additionally, an upper spray assembly 142 may be located above upper rack assembly 126 along the vertical direction V. In this manner, upper spray assembly 142 may be configured for urging and/or cascading a flow of wash fluid downward over rack assemblies 122, 124, and 126. As further illustrated in FIG. 2, upper rack assembly 126 may further define an integral spray manifold 144, which is generally configured for urging a flow of wash fluid substantially upward along the vertical direction V through upper rack assembly 126.

The various spray assemblies and manifolds described herein may be part of a fluid distribution system or fluid circulation assembly 150 for circulating water and wash fluid in tub 104. More specifically, fluid circulation assembly 150 includes a circulation pump 152 for circulating water and wash fluid (e.g., detergent, water, and/or rinse aid) in tub 104. Circulation pump 152 is located within sump 138 or within a machinery compartment located below sump 138 of tub 104. Circulation pump 152 is in fluid communication with an external water supply line (not shown) and sump 138. A water inlet valve 153 can be positioned between the external water supply line and circulation pump 152 to selectively allow water to flow from the external water supply line to circulation pump 152. Additionally or alternatively, water inlet valve 153 can be positioned between the external water supply line and sump 138 to selectively allow water to flow from the external water supply line to sump 138. Water inlet valve 153 can be selectively controlled to open to allow the flow of water into dishwasher 100 and can be selectively controlled to cease the flow of water into dishwasher 100. Further, fluid circulation assembly 150 may include one or more fluid conduits or circulation piping for directing water and/or wash fluid from circulation pump 152 to the various spray assemblies and manifolds. For example, for the embodiment depicted in FIG. 2, a primary supply conduit 154 extends from circulation pump 152, along rear 112 of tub 104 along the vertical direction V to supply wash fluid throughout wash chamber 106.

As further illustrated in FIG. 2, primary supply conduit 154 is used to supply wash fluid to one or more spray assemblies, e.g., to mid-level spray arm assembly 140 and upper spray assembly 142. However, it should be appreciated that according to alternative embodiments, any other suitable plumbing configuration may be used to supply wash fluid throughout the various spray manifolds and assemblies described herein. For example, according to another exemplary embodiment, primary supply conduit 154 could be used to provide wash fluid to mid-level spray arm assembly 140 and a dedicated secondary supply conduit (not shown) could be utilized to provide wash fluid to upper spray assembly 142. Other plumbing configurations may be used for providing wash fluid to the various spray devices and manifolds at any location within dishwasher appliance 100.

Each spray arm assembly 134, 140, 142, integral spray manifold 144, or other spray device may include an arrangement of discharge ports or orifices for directing wash fluid received from circulation pump 152 onto dishes or other articles located in wash chamber 106. The arrangement of the discharge ports, also referred to as jets, apertures, or orifices, may provide a rotational force by virtue of wash fluid flowing through the discharge ports. Alternatively, spray arm assemblies 134, 140, 142 may be motor-driven, or may operate using any other suitable drive mechanism. Spray manifolds and assemblies may also be stationary. The resultant movement of the spray arm assemblies 134, 140, 142 and the spray from fixed manifolds provides coverage of dishes and other dishwasher contents with a washing spray. Other configurations of spray assemblies may be used as well. For example, dishwasher 100 may have additional spray assemblies for cleaning silverware, for scouring casserole dishes, for spraying pots and pans, for cleaning bottles, etc.

In operation, circulation pump 152 draws wash fluid in from sump 138 and pumps it to a diverter 156, e.g., which is positioned within sump 138 of dishwasher appliance. Diverter 156 may include a diverter disk (not shown) disposed within a diverter chamber 158 for selectively distributing the wash fluid to the spray arm assemblies 134, 140, 142 and/or other spray manifolds or devices. For example, the diverter disk may have a plurality of apertures that are configured to align with one or more outlet ports (not shown) at the top of diverter chamber 158. In this manner, the diverter disk may be selectively rotated to provide wash fluid to the desired spray device.

According to an exemplary embodiment, diverter 156 is configured for selectively distributing the flow of wash fluid from circulation pump 152 to various fluid supply conduits, only some of which are illustrated in FIG. 2 for clarity. More specifically, diverter 156 may include four outlet ports (not shown) for supplying wash fluid to a first conduit for rotating lower spray arm assembly 134 in the clockwise direction, a second conduit for rotating lower spray arm assembly 134 in the counter-clockwise direction, a third conduit for spraying an auxiliary rack such as the silverware rack, and a fourth conduit for supply mid-level and/or upper spray assemblies 140, 142, e.g., such as primary supply conduit 154.

Drainage of soiled water within sump 138 may occur, for example, through drain assembly 166. In particular, water may exit sump through a drain and may flow through a drain conduit 167. A drain pump 168 may facilitate drainage of the soiled water by pumping the water to a drain line external to the dishwasher 100.

Dishwasher 100 is further equipped with a controller 160 to regulate operation of dishwasher 100. Controller 160 may include one or more memory devices and one or more microprocessors, such as general or special purpose microprocessors operable to execute programming instructions or micro-control code associated with a cleaning cycle. The memory may represent random access memory such as DRAM, or read only memory such as ROM or FLASH. In some embodiments, the processor executes programming instructions stored in memory. The memory may be a separate component from the processor or may be included onboard within the processor. Alternatively, controller 160 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 160 may be positioned in a variety of locations throughout dishwasher 100. In the illustrated embodiment, controller 160 may be located within a control panel area 162 of door 116 as shown in FIGS. 1 and 2. In such an embodiment, input/output (“I/O”) signals may be routed between the control system and various operational components of dishwasher 100 along wiring harnesses that may be routed through the bottom of door 116. Typically, the controller 160 includes a user interface panel/controls 164 through which a user may select various operational features and modes and monitor progress of dishwasher 100. In one embodiment, the user interface 164 may represent a general purpose I/O (“GPIO”) device or functional block. In one embodiment, the user interface 164 may include input components, such as one or more of a variety of electrical, mechanical or electro-mechanical input devices including rotary dials, push buttons, and touch pads. The user interface 164 may include a display component, such as a digital or analog display device designed to provide operational feedback to a user. The user interface 164 may be in communication with the controller 160 via one or more signal lines or shared communication busses.

It should be appreciated that the invention is not limited to any particular style, model, or configuration of dishwasher 100. The exemplary embodiment depicted in FIGS. 1 and 2 is for illustrative purposes only. For example, different locations may be provided for user interface 164, different configurations may be provided for rack assemblies 122, 124, 126, different spray arm assemblies 134, 140, 142 and spray manifold configurations may be used, and other differences may be applied while remaining within the scope of the present subject matter.

With reference still to FIG. 2, in some instances, tub 104 of dishwasher 100 may experience a tub overfill or flood event, e.g., when wash fluid floods over a tub lip 170 of tub 104. Such an overfill or flood event can occur as a result of any number of conditions, such as e.g., an out-of-level condition, an inlet water valve failure, and/or a drain pump failure. Accordingly, in accordance with exemplary aspects of the present disclosure, dishwasher 100 may utilize outputs from a pressure sensor 200 and feedback from a tub lip sensor 202 to detect and/or prevent flood events.

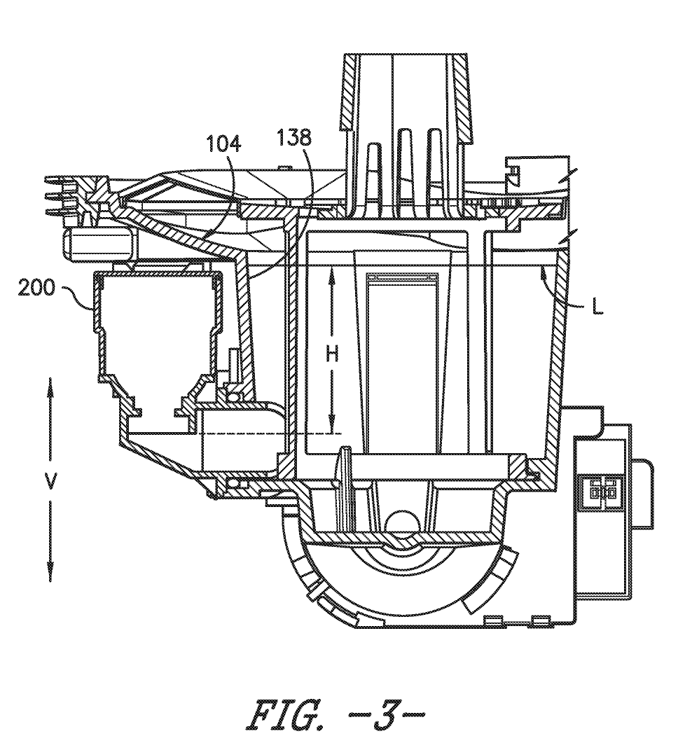

FIG. 3 provides a close up, cross sectional view of sump 138 and pressure sensor 200 mounted thereto of the dishwasher 100 of FIGS. 1 and 2. Pressure sensor 200 is operatively configured to detect a liquid level L within sump 138 and then communicate the liquid level L to controller 160 via one or more signals. Thus, pressure sensor 200 and controller 160 are communicatively coupled. The pressure sensor 200 can send signals to controller 160 as a frequency, as an analog signal, or in another suitable manner. Pressure sensor 200 can be any suitable type of sensor capable of sensing the liquid level L within dishwasher 100.

For the depicted embodiment of FIG. 3, pressure sensor 200 is configured to sense the height H of the water above pressure sensor 200 along the vertical direction V, e.g., by measuring the pressure on pressure sensor 200. In particular, for this embodiment, pressure sensor 200 includes a pressure plate that is acted on by the pressure of the wash fluid within sump 138. As the liquid level L rises, the pressure plate is pushed upward along the vertical direction V and thus compresses air trapped within the housing and a diaphragm of pressure sensor 200, which causes the diaphragm to flex or alter its position. As a result of the pressure and consequent movement of the diaphragm, a permanent magnet attached to the diaphragm may change its position in relation to a Hall-effect transducer. The transducer delivers one or more electrical signals proportional to the magnetic field of the magnet. The signals may be linearized, digitized, and/or amplified before being sent to controller 160 for processing. The pressure sensor may include a printed circuit board (PCB) board to electrically connect the various electrical components. As noted above, other types of pressure sensors 200 are contemplated.

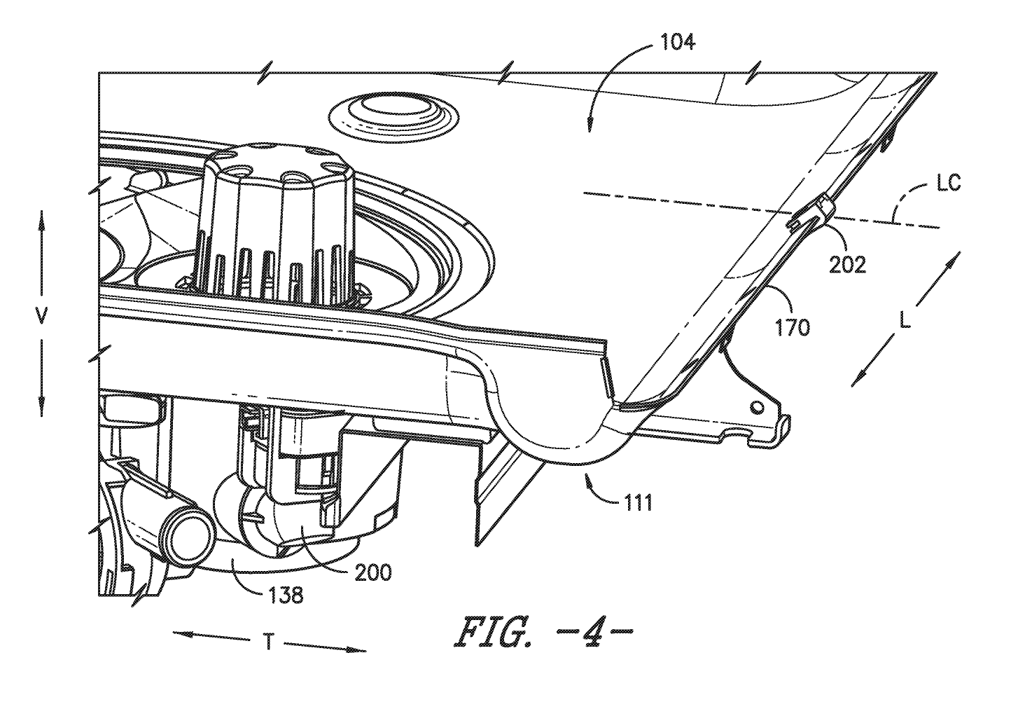

FIG. 4 provides a perspective view of tub lip sensor 202 coupled with or attached to tub lip 170 of tub 104 of the dishwasher appliance 100 of FIGS. 1 and 2. Tub lip sensor 202 is operatively configured to detect high water or wash fluid levels within tub 104, and more particularly, tub lip sensor 202 is configured to sense wash fluid that is at or proximate tub lip 170. In this way, appropriate action can be taken to prevent an overfill or flood event.

Notably, for the depicted embodiment of FIG. 4, tub lip sensor 202 is positioned on or mounted to tub lip 170 of tub 104, and more particularly, tub lip sensor 202 is positioned on or mounted to tub lip 170 at front side 111 of tub 104 for this embodiment. By positioning tub lip sensor 202 at or on tub lip 170, tub lip sensor 202 does not interfere with the water flow through sump 138 during wash or drain cycles and takes up a minimal amount of space, e.g., compared to float sensors. In addition, by placing tub lip sensor 202 at front side 111 of tub 104, tub lip sensor 202 is advantageously positioned to detect water spillage or floods over the front portion of tub 104, which is a location where water is likely to spill or flood onto the floor of a consumer's home in the event of a water breach over this portion of tub 104. Further, for this embodiment, tub lip sensor 202 is positioned approximately along a lateral centerline LC that extends along the transverse direction T midway along the lateral length of tub 104. In this way, tub lip sensor 170 may still detect high wash fluid levels during out-of-level conditions, e.g., tilting of the dishwasher 100 about the transverse direction T.

In the depicted embodiment of FIG. 4, tub lip sensor 202 is a conductivity sensor. That is, when water or wash fluid fills up to tub lip 170, the wash fluid bridges leads or electrical contacts of tub lip sensor 202, thus allowing an electrical current to travel from one lead to the other. This completes a circuit that includes the electrical leads of tub lip sensor 202 and controller 160, among other possible electrical components. The change or increase in electrical current through the circuit is indicative that wash fluid is present or sensed at tub lip 170. The change in electrical current through the circuit can be measured by any suitable parameter (e.g., a change in current, voltage, or resistance) and by any suitable device (e.g., a multimeter positioned within controller 160).

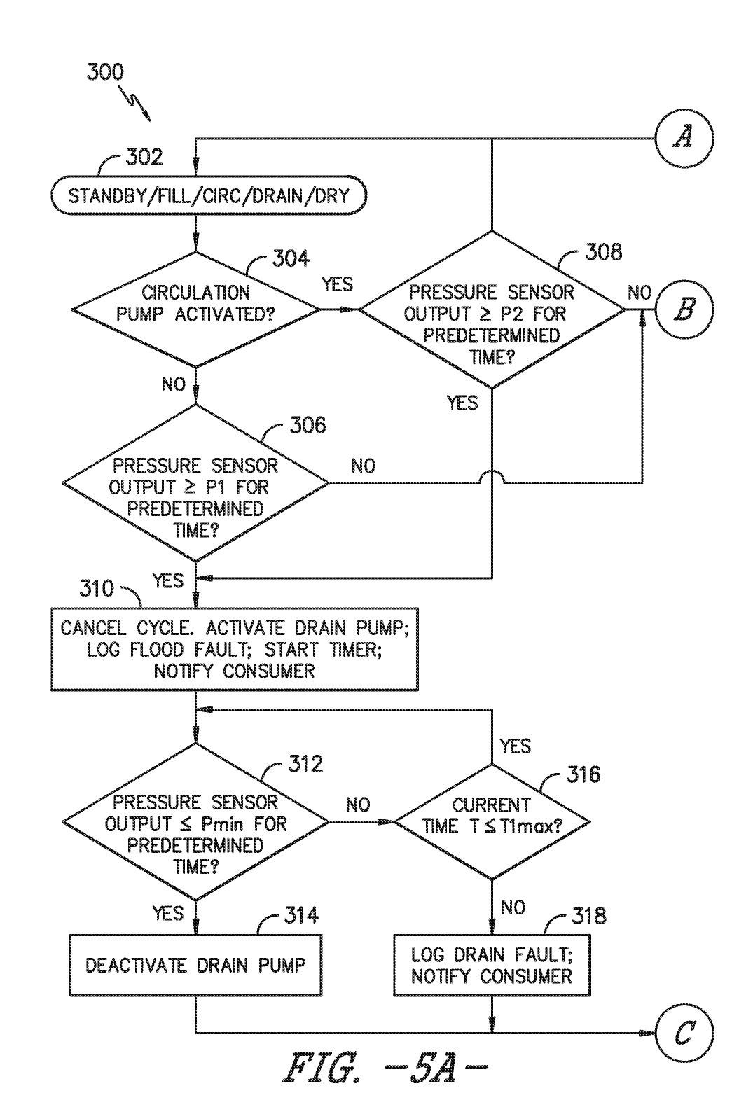

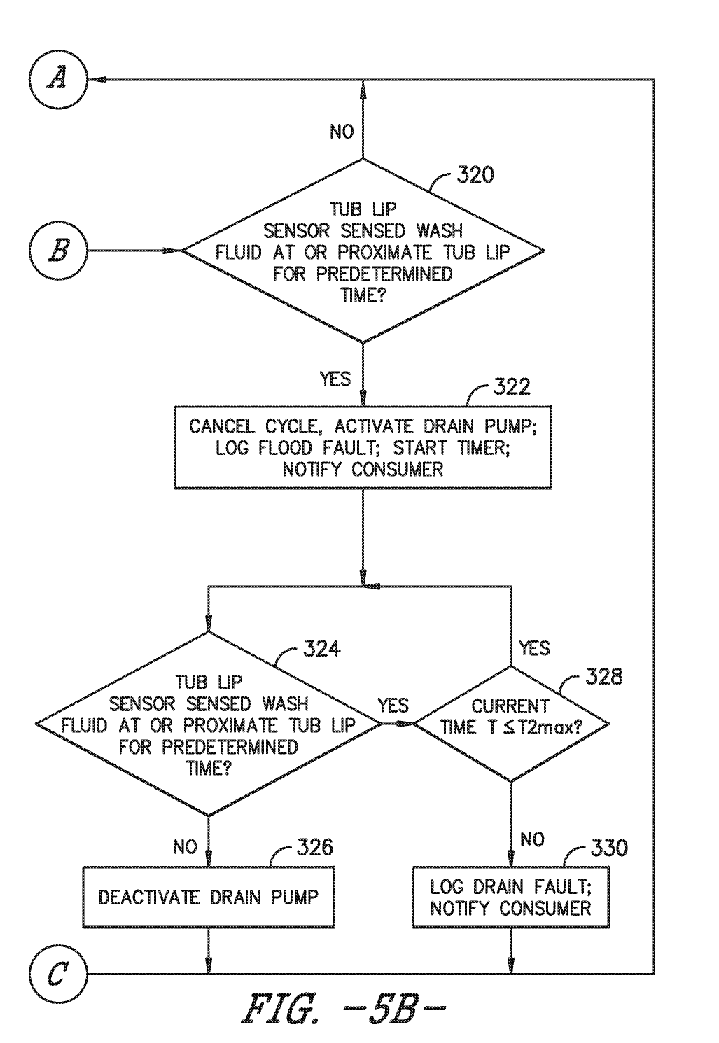

FIGS. 5A and 5B provide a flow diagram of an exemplary method (300) for detecting and/or preventing a flood event of a dishwasher appliance according to exemplary embodiments of the present disclosure. For instance, the method (300) can be used to detect and/or prevent floods of the dishwasher appliance 100 of FIGS. 1 through 4. Further, as will be explained below, outputs of the pressure sensor 200 of FIGS. 2 and 3 and the tub lip sensor 202 of FIGS. 2 and 4 can be utilized to detect and prevent flood events of dishwasher 100. To provide context to exemplary method (300), the reference numerals used in FIGS. 1 through 4 to describe the features of dishwasher 100 will be used below. It will be appreciated, however, that method (300) is not limited in scope to dishwasher 100 of FIGS. 1 through 4; rather, method (300) is applicable to other suitable types and models of dishwashers.

At (302), method (300) includes powering up or operating a dishwasher. For instance, dishwasher 100 can be powered in a standby mode (e.g., power is supplied to dishwasher 100 but dishwasher is not performing a cycle). Moreover, dishwasher 100 can be operated in a given cycle, including for example, a fill cycle, a circulation cycle, a drain cycle, or a dry cycle. So long as power is supplied to dishwasher 100, method (300) commences.

In some implementations, when method (300) commences at (302), controller 160 receives a pressure sensor output indicative of the liquid level L within sump 138. For instance, for this implementation, controller 160 receives a signal from pressure sensor 200 indicative of the height H of the wash fluid above pressure sensor 200, which is in turn indicative of the liquid level L within sump 138. Controller 160 can receive the pressure sensor output directly or indirectly from pressure sensor 200. Preferably, controller 160 receives pressure sensor outputs continuously at a predetermined interval, such as e.g., every tenth of a second, every half second, every second, etc. In this way, dishwasher 100 constantly monitors for flood events.

At (304), method (300) includes determining whether the circulation pump is activated. Stated differently, method (300) includes determining whether wash fluid is being circulated about or through dishwasher 100. As one example, to determine whether circulation pump 152 is activated, controller 160 can receive one or more signals from circulation pump 152 indicating that circulation pump 152 is activated. As another example, controller 160 can be configured to control circulation pump 152 and logic within controller 160 can be used to determine whether circulation pump 152 is activated. Determining whether circulation pump 152 is activated can be determined in other suitable manners as well.

Notably, for this embodiment, determining whether circulation pump 152 is active will determine which pressure threshold will be compared against the pressure sensor output received by controller 160. That is, whether the circulation pump 152 is activated determines whether the pressure sensor output is compared to a first pressure threshold P1 at (306) or a second pressure threshold P2 at (308). If the circulation pump is not activated as determined at (304) (i.e., there is no wash fluid being circulated through dishwasher 100), most or at least a majority of the wash fluid is held in sump 138. If the circulation pump is activated as determined at (304) (i.e., circulation pump 152 is circulating water and wash fluid through dishwasher 100), the liquid level L within sump 138 is expected to be lower as some of the wash fluid is actively being dispersed by one or more of the spray arm assemblies 134, 140, 142. Thus, there is less wash fluid in sump 138 when circulation pump 152 is active compared to when the circulation pump 152 is not active. As such, there are different pressure thresholds depending on whether circulation pump 152 is activated, and for this embodiment, the first pressure threshold P1 is a greater than the second pressure threshold P2.

At (306), if the circulation pump is not activated as determined at (304), then method (300) includes determining whether a pressure sensor output of the pressure sensor is greater than or equal to a first pressure threshold for a predetermined time. That is, at (306) it is determined whether the pressure sensor output received by controller 160 is greater than or equal to the first pressure threshold P1 for a predetermined time. The predetermined time can be, for example, between about three (3) and five (5) seconds. Preferably, in some implementations, in determining whether the pressure sensor output of pressure sensor 200 is greater than or equal to the first pressure threshold P1 for the predetermined time, the pressure sensor output must be consecutively greater than or equal to the first pressure threshold P1 for the predetermined time. In this way, it is less probable or likely that pressure sensor 200 has been inadvertently or nuisance tripped.

If at (306) it is determined that the pressure sensor output is not greater than or equal to the first pressure threshold P1, then the controller logic proceeds to (320) to check to see if wash fluid is present at the tub lip, as will be explained in greater detail below. In this way, in the event pressure sensor 200 fails or otherwise fails to correctly output the pressure sensor output indicative of the liquid level L within dishwasher 100, dishwasher 100 may still detect and/or prevent flood events. If, however, at (306) it is determined that the pressure sensor output is greater than or equal to the first pressure threshold P1, then it is determined that there is presently a flood event or about to be a flood event in dishwasher 100. As such, the controller logic proceeds to (310).

At (308), if the circulation pump is activated as determined at (304), then method (300) includes determining whether the pressure sensor output of the pressure sensor is greater than or equal to a second pressure threshold for a predetermined time. That is, at (308) it is determined whether the pressure sensor output received by controller 160 is greater than or equal to the second pressure threshold P2 for a predetermined time. The predetermined time can be between about three (3) and five (5) seconds, for example. In some implementations, in determining whether the pressure sensor output of pressure sensor 200 is greater than or equal to the second pressure threshold P2 for the predetermined time, the pressure sensor output must be consecutively greater than or equal to the second pressure threshold P2 for the predetermined time. In this way, it is less probable or likely that pressure sensor 200 has been inadvertently or nuisance tripped.

If at (308) it is determined that the pressure sensor output is not greater than or equal to the second pressure threshold P2, then the controller logic proceeds to (320) to check to see if wash fluid is present at the tub lip. In this manner, in the event pressure sensor 200 fails or otherwise fails to correctly output the pressure sensor output indicative of the liquid level L within dishwasher 100, dishwasher 100 may still detect and/or prevent flood events. If, however, at (308) it is determined that the pressure sensor output is greater than or equal to the second pressure threshold P2, then it is determined that there is presently a flood event or about to be a flood event in dishwasher 100. As such, the controller logic proceeds to (310).

At (310), the method (300) includes activating the drain pump if the pressure sensor output is greater than or equal to either the first pressure threshold for the predetermined time or the second pressure threshold for the predetermined time. Thus, corrective action in response to the detected flood event can be taken. Preferably, drain pump 168 removes wash fluid from sump 138 and tub 104 at a faster rate than water and/or wash fluid flows into sump 138. In this manner, drain pump 168 can overcome the flow rate of water inlet valve 153, particularly if water inlet valve 153 has failed. Further, in some implementations, drain pump 168 removes wash fluid from sump 138 at twice or at least twice the rate of wash fluid entering sump 138. As one example, drain pump 168 removes fluid from sump 138 at three (3) gallons per minute (gpm) and water inlet valve 153 allows for a flow rate into sump 138 at a flow rate of 0.8 gpm.

In some implementations, at (310), the method (300) includes starting a timer. The starter can be a component of controller 160 or can be a separate component communicatively coupled with controller 160, for example. In such implementations, as will be explained below, the timer is started so that if the liquid level L within sump 138 is not below a certain threshold within a predetermined time, the consumer is notified so that corrective action may be taken. Moreover, preferably, the starting of the timer is coordinated with the activation of drain pump 168. That is, the timer is started upon activation of drain pump 168. In this way, the activated drain pump 168 does not run indefinitely without the consumer being notified in the event the drain pump 168 simply cannot remove the wash fluid from sump 138, e.g., due to a water inlet valve failure. This may, for example, improve the service life of drain pump 168.

In implementations where dishwasher 100 is performing a cycle, particularly a rinse or wash cycle, additionally or alternatively to activating drain pump 168, method (300) includes cancelling a current cycle of the dishwasher appliance if the pressure sensor output is greater than or equal to either the first pressure threshold P1 or the second pressure threshold P2 as determined at (306) or (308), respectively. When the pressure sensor output is greater than or equal to either the first pressure threshold P1 or the second pressure threshold P2, controller 160 effectively determines that a flood event has occurred or is on the verge or precipice of a flood event, as noted above. Thus, equipped with such information, dishwasher 100 can take corrective action to potentially prevent the flood event or reduce the potential damage of the flood event.

As one example, as noted above, the current cycle being performed by dishwasher appliance 100 can be canceled. For instance, if dishwasher 100 is performing a wash or rinse cycle, to cancel the cycle, the method (300) can include deactivating water inlet valve 153 (e.g., closing the valve to a closed position (assuming it is still operable)) to prevent further water from entering dishwasher 100. Moreover, method (300) can likewise include deactivating circulation pump 152. In this way, energy can be conserved and will allow the wash fluid to flow back to sump 138 such that it can be removed from dishwasher 100.

In some further implementations, at (310), the method (300) includes logging a flood fault. In this way, if dishwasher 100 is serviced, an operator can quickly ascertain why dishwasher 100 was cancelled mid-cycle. Moreover, in some implementations, as shown at (310), the method (300) includes notifying a consumer that the cycle has been cancelled and that a flood event or possible flood event has occurred. For instance, as one example, dishwasher 100 may include a speaker that audibly communicates the notification to a consumer. As another example, dishwasher 100 may include a communication interface that is communicatively coupled with controller 160. The communication interface may include a network interface that provides for communication over a network, such as e.g., a wireless network. In such implementations, dishwasher 100 may send notifications to a consumer's user device, such as e.g., a cell phone.

At (312), the method (300) includes determining whether the pressure sensor output is less than or equal to a minimum pressure threshold P_{MIN} for a predetermined time. That is, the pressure sensor outputs received by controller 160 are compared to a minimum pressure threshold P_{MIN}. The minimum pressure threshold P_{MIN} corresponds with a liquid level L within sump 138 that provides a degree of safety that dishwasher appliance 100 is not currently flooded or not about to be flooded. In some implementations, in determining whether the pressure sensor output is less than or equal to the minimum pressure threshold P_{MIN}, the pressure sensor output must be consecutively less than or equal to the minimum pressure threshold P_{MIN} for the predetermined time. In this way, it is less probable or likely that pressure sensor 200 has been inadvertently or nuisance tripped. The predetermined time can be, for example, between about three (3) and five (5) seconds.

If at (312) it is determined that the pressure sensor output is less than or equal to the minimum pressure threshold P_{MIN} for the predetermined time, then it is determined that there is no longer a flood or threat of a flood within dishwasher 100, and as will be explained below at (314), drain pump 168 is deactivated. If, however, at (312) it is determined that the pressure sensor output is not less than or equal to the minimum pressure threshold P_{MIN}, then a current time T is compared against a predetermined time threshold T1_{MAX} at (316).

At (314), if the pressure sensor output is less than or equal to the minimum pressure threshold P_{MIN} for the predetermined time, the method (300) includes deactivating the drain pump. As noted above, if it is determined at (312) that the pressure sensor output is less than or equal to the minimum pressure threshold P_{MIN}, then there is no longer a flood event or threat of a flood event. As such, to save energy, drain pump 168 is deactivated.

At (316), if the pressure sensor output is not less than or equal to the minimum pressure threshold P_{MIN} for the predetermined time, the method (300) includes determining whether a current time is less than or equal to a predetermined time threshold T1_{MAX}. The predetermined time threshold T1_{MAX} can be, for example, twelve (12) hours, twenty-four (24) hours, thirty-six (36) hours, forty-eight hours (48), etc. The predetermined time threshold T1_{MAX} is kept by the timer.

If the current time T is less than or equal to the predetermined time threshold T_{MAX}, the controller logic loops back to (312). In this way, controller 160 can continue to monitor the liquid level L within sump 138. If the current time T is not less than or equal to predetermined time threshold T1_{MAX}, then the controller logic proceeds to (318).

At (318), if the current time T is not less than or equal to the predetermined time threshold T1_{MAX}, the method (300) includes logging a drain fault. If the current time T is not less than or equal to the predetermined time threshold T1_{MAX}, controller 160 recognizes that for one reason or another the wash fluid within sump 138 cannot be removed. For example, in implementations where drain pump 168 is activated and cannot remove the wash fluid from sump 138 within predetermined time threshold T1_{MAX}, the system recognizes that there is a malfunction of some component (e.g., water inlet valve 153) that is preventing the wash fluid from being drained from sump 138. The drain fault is logged to assist an operator with taking corrective action.

Further, in some implementations at (318), the method (300) includes notifying a consumer that there has been a drain failure. In this way, a consumer can take necessary corrective actions to prevent dishwasher 100 from flooding. A consumer may be notified in any of the exemplary ways noted above at (310).

After the logging the drain fault and/or notifying the consumer at (318), the controller logic proceeds or returns to (302) to commence the process once again. As noted above, if dishwasher 100 is powered, controller 160 can constantly monitor for flood events.

At (320), if the pressure sensor output is not greater than or equal to either the first pressure threshold or the second pressure threshold as determined at (306) or (308), respectively, the method (300) includes determining whether the tub lip sensor has sensed wash fluid at or proximate the tub lip for a predetermined time. That is, at (320) it is determined whether the tub lip sensor 202 has sensed wash fluid at or proximate tub lip 170 for a predetermined time. The predetermined time can be, for example, between about three (3) and five (5) seconds. Preferably, in some implementations, in determining whether the tub lip sensor 202 has sensed wash fluid at or proximate tub lip 170 consecutively for the predetermined time. Stated alternatively, tub lip sensor 202 must sense wash fluid at or proximate the tub lip 170 for the predetermined time for the entire predetermined period. In this way, it is less probable or likely that tub lip sensor 202 has been inadvertently or nuisance tripped.

As one example, where tub lip sensor 202 is a conductivity sensor as noted above, to sense wash fluid at or proximate tub lip 170, if the tub lip sensor 202 is closed for a consecutive predetermined time (e.g., wash fluid has breached the leads of the sensor for a consecutive period of time), it may be determined that wash fluid is present at or proximate tub lip 170, and thus, a flood event has likely occurred or about the occur. If, however, the tub lip sensor 202 remains open or has not closed for a consecutive predetermined time, a determination may be made that wash fluid is not present at or proximate tub lip 170. Consequently, it may be determined that a flood event has likely not occurred or about to occur.

If at (320) it is determined that tub lip sensor 202 has not sensed wash fluid proximate tub lip 170 for the predetermined time, then it is determined that there is not currently a flood event or about to be a flood event and the controller logic loops back to (302) and method (300) begins again as shown in FIG. 5A.

If, however, at (320) it is determined that tub lip sensor 202 has sensed wash fluid proximate tub lip 170 for the predetermined time, then it is determined that there is presently a flood event or about to be a flood event in dishwasher 100. As such, the controller logic proceeds to (322). In such an event, it is possible that the pressure sensor 200 gave a false positive at (306) or (308) or has malfunctioned. Thus, in accordance with exemplary aspects of the present disclosure, corrective action may be taken.

At (322), the method (300) includes activating the drain pump if the tub lip sensor has sensed wash fluid at or proximate the tub lip for the predetermined time. Thus, corrective action in response to the detected flood event can be taken. Preferably, drain pump 168 removes wash fluid from dishwasher 100 at a faster rate than water and/or wash fluid flows into sump 138. In this manner, drain pump 168 can overcome the flow rate of water inlet valve 153, particularly if water inlet valve 153 has failed.

In some implementations, at (322) the method (300) includes starting a timer. In such implementations, as will be explained further below, the timer is started so that if the liquid level L within sump 138 is not below a certain threshold within a predetermined time, the consumer is notified so that corrective action may be taken. Moreover, preferably, the starting of the timer is coordinated with the activation of drain pump 168. That is, the timer is started upon activation of drain pump 168. In this way, the activated drain pump 168 does not run indefinitely without the consumer being notified in the event the drain pump 168 simply cannot remove the wash fluid from dishwasher 100, e.g., due to a water inlet valve failure. This may also, for example, improve the service life of drain pump 168.

In implementations where dishwasher 100 is operating a cycle, the method (300) includes canceling a current cycle of the dishwasher appliance if the tub lip sensor has sensed wash fluid at or proximate the tub lip for the predetermined time. When wash fluid is sensed or detected at or proximate tub lip 170 or at a given distance from tub lip 170, controller 160 determines that a flood event has occurred or that a flood event is imminent. Thus, in response, dishwasher 100 can take corrective action to prevent or mitigate the effects of the flood event, as noted above.

By way of example, if dishwasher 100 is performing a wash or rinse cycle, canceling the current cycle includes deactivating the inlet water valve and/or deactivating the circulation pump. Deactivating water inlet valve 153 (e.g., closing the valve to a closed position) prevents further water from entering dishwasher 100. Deactivating circulation pump 152 ceases the circulation of wash fluid through or about dishwasher 100. In this way, energy can be conserved and will allow the wash fluid to flow back to sump 138 such that it can be removed from dishwasher 100.

In some further implementations, at (322), the method (300) includes logging a flood fault. In this way, if dishwasher 100 is serviced, an operator can quickly ascertain why dishwasher 100 was cancelled mid-cycle. Moreover, in some implementations, as shown at (322), the method (300) includes notifying a consumer that the cycle has been cancelled and that a flood event or possible flood event has occurred. For instance, as noted previously, dishwasher 100 may include a speaker that audibly communicates the notification to a consumer. As another example, dishwasher 100 may include a communication interface that is communicatively coupled with controller 160. The communication interface may include a network interface that provides for communication over a network, such as e.g., a wireless network. In such implementations, dishwasher 100 may send notifications to a consumer's user device, such as e.g., a watch.

At (324), after canceling and/or activating the drain pump at (322), the method (300) includes determining whether the tub lip sensor has sensed wash fluid at or proximate the tub lip for a predetermined time. Stated alternatively, after one or more corrective actions are taken, e.g., canceling the current cycle and/or activating the drum pump, controller 160 monitors whether the wash fluid within sump 138 and tub 104 has receded for a predetermined time, such as e.g., about three (3) to five (5) seconds. As one example, the controller 160 can determine whether the tub lip sensor 202 has been electrically opened consecutively for a predetermined time (e.g., two (2) seconds). Stated differently, the controller 160 can determine whether wash fluid has bridged the electrical leads of the conductivity tub lip sensor 202 for a predetermined time.

If at (324) it is determined that the tub lip sensor has not sensed wash fluid at or proximate the tub lip for the predetermined time, then it is determined that there is no longer a flood event or threat of a flood event within dishwasher 100, and as will be explained below at (326), drain pump 168 is deactivated. If, however, at (324) it is determined that the tub lip sensor has sensed wash fluid at or proximate the tub lip for the predetermined time, then the current time T is compared against a predetermined time threshold T2_{MAX} at (328).

At (326), the method (300) includes if the tub lip sensor has not sensed wash fluid at or proximate the tub lip for a predetermined time as determined at (324), the method (300) includes deactivating the drain pump. As noted above, if it is determined at (324) that the tub lip sensor has not sensed wash fluid at or proximate the tub lip for the predetermined time, then there is no longer a flood event or threat of a flood event. As such, to save energy, drain pump 168 is deactivated.

At (328), if the tub lip sensor has sensed wash fluid proximate the tub lip for the predetermined time at (324), the method (300) includes determining whether current time T is less than or equal to a predetermined time threshold T2_{MAX}. The predetermined time threshold T2_{MAX} can be, for example, twelve (12) hours, twenty-four (24) hours, thirty-six (36) hours, forty-eight hours (48), etc. The predetermined time threshold T2_{MAX} is kept by the timer.

If the current time T is less than or equal to the predetermined time threshold T2_{MAX}, the controller logic loops back to (324). In this way, controller 160 can continue to monitor whether wash fluid is at or proximate tub lip 170. If the current time T is not less than or equal to predetermined time threshold T2_{MAX}, then the controller logic proceeds to (330).

At (330), if the current time T is not less than or equal to the predetermined time threshold T2_{MAX}, the method (300) includes logging a drain fault. If the current time T is not less than or equal to the predetermined time threshold T2_{MAX}, controller 160 recognizes that the wash fluid proximate or at tub lip 170 has not receded. For example, in implementations where drain pump 168 is activated and cannot remove the wash fluid from sump 138 and tub 104 within predetermined time threshold T2_{MAX}, the system recognizes that there is a malfunction of some component (e.g., water inlet valve 153) that is preventing the wash fluid from being drained from dishwasher 100. The drain fault is logged to assist an operator with taking corrective action.

Further, in some implementations at (330), the method (300) includes notifying a consumer that there has been a drain failure. In this way, a consumer can take necessary corrective actions to prevent dishwasher 100 from flooding. A consumer may be notified in any of the exemplary ways noted above at (310) and (322).

After the logging the drain fault and/or notifying the consumer at (330), the controller logic proceeds or returns to (302) to commence the process once again. As noted above, if dishwasher 100 is powered, controller 160 can constantly monitor for flood events.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method for detecting a flood event in a dishwasher appliance, the dishwasher appliance comprising a cabinet and a tub positioned within the cabinet, the tub comprising a tub lip, the dishwasher appliance further comprising a pressure sensor, a tub lip sensor, a drain pump, and a circulation pump, the method comprising:
determining whether the circulation pump is activated;
determining whether a pressure sensor output of the pressure sensor is greater than or equal to a first pressure threshold for a predetermined time if the circulation pump is not activated, or, determining whether the pressure sensor output of the pressure sensor is greater than or equal to a second pressure threshold for a predetermined time if the circulation pump is activated;
determining whether the tub lip sensor has sensed wash fluid at or proximate the tub lip for a predetermined time if the pressure sensor output is not greater than or equal to either the first pressure threshold for the predetermined time or the second pressure threshold for the predetermined time; and
activating the drain pump if the tub lip sensor has sensed wash fluid at or proximate the tub lip for the predetermined time.

2. The method of claim 1, further comprising:
canceling a current cycle of the dishwasher appliance if the tub lip sensor sensed wash fluid at or proximate the tub lip for the predetermined time.

3. The method of claim 2, wherein the dishwasher appliance comprises a water inlet valve, and wherein canceling comprises deactivating the water inlet valve of the dishwasher appliance and deactivating the circulation pump.

4. The method of claim 1, wherein the method further comprises:
notifying a consumer of the flood event.

5. The method of claim 1, wherein after activating the drain pump, the method further comprises:
determining whether the tub lip sensor has sensed wash fluid at or proximate the tub lip for a predetermined time.

6. The method of claim 5, wherein after determining whether the tub lip sensor has sensed wash fluid at or proximate the tub lip for the predetermined time, the method further comprises:
deactivating the drain pump if the tub lip sensor has not sensed wash fluid at or proximate the tub lip for the predetermined time.

7. The method of claim 5, wherein after activating the drain pump and after determining whether the tub lip sensor has sensed wash fluid at or proximate the tub lip for the predetermined time, the method further comprises:
determining whether a current time is less than or equal to a predetermined time threshold if the tub lip sensor has sensed wash fluid proximate the tub lip for the predetermined time.

8. The method of claim 7, wherein after determining whether the current time is less than or equal to the predetermined time threshold, the method further comprises:
logging a drain fault if the current time is not less than or equal to the predetermined time threshold.

9. The method of claim 7, wherein after determining whether the current time is less than or equal to the predetermined time threshold, the method further comprises:
determining whether the pressure sensor output is less than or equal to the minimum pressure threshold if the current time is less than or equal to the predetermined time threshold.

10. The method of claim 1, wherein during determining whether the tub lip sensor has sensed wash fluid proximate the tub lip for the predetermined time, the tub lip sensor must sense wash fluid at or proximate the tub lip consecutively for the predetermined time.

11. The method of claim 1, wherein after determining whether the tub lip sensor has sensed wash fluid at or proximate the tub lip for the predetermined time, the method further comprises:
logging a flood fault if the tub lip sensor has sensed wash fluid at or proximate the tub lip for the predetermined time.

12. A dishwasher appliance, comprising:
a cabinet;
a tub positioned within the cabinet and defining a wash chamber for receipt of articles for washing, the tub comprising a tub lip;
a tub lip sensor positioned proximate the tub lip;
one or more spray assemblies;
a circulation pump for circulating wash fluid to the one or more spray arm assemblies;
a drain pump;
a sump;
a pressure sensor mounted to the sump;
a controller communicatively coupled with the pressure sensor, the tub lip sensor, the drain pump, and the circulation pump, the controller configured to:
determine whether the circulation pump is activated;
determine whether a pressure sensor output of the pressure sensor is greater than or equal to a first pressure threshold for a predetermined time if the circulation pump is not activated, or, determine whether the pressure sensor output of the pressure sensor is greater than or equal to a second pressure threshold for a predetermined time if the circulation pump is activated;
determine whether the tub lip sensor has sensed wash fluid at or proximate the tub lip for a predetermined time if the pressure sensor output is not greater than or equal to either the first pressure threshold for the predetermined time or the second pressure threshold for the predetermined time; and
activate the drain pump if the controller determines that the tub lip sensor has sensed wash fluid at or proximate the tub lip for the predetermined time.

13. The dishwasher appliance of claim 12, wherein after the controller determines whether the tub lip sensor has sensed wash fluid at or proximate the tub lip for the predetermined time, the controller is further configured to:
cancel a current cycle of the dishwasher appliance if the tub lip sensor has sensed wash fluid at or proximate the tub lip for the predetermined time.

14. The dishwasher appliance of claim 13, further comprising:
an inlet water valve communicatively coupled with the controller;
wherein when the controller cancels the current cycle, the controller is configured to:
deactivate the inlet water valve; and
deactivate the circulation pump.

15. The dishwasher appliance of claim 12, wherein after the controller activates the drain pump, the controller is further configured to:
determine if the tub lip sensor has sensed wash fluid at or proximate the tub lip for a predetermined time; and
deactivate the drain pump if the tub lip sensor has not sensed wash fluid at or proximate the tub lip for the predetermined time.

16. The dishwasher appliance of claim 12, further comprising:
a communication interface communicatively coupled with the controller, and wherein when the controller cancels a current cycle of the dishwasher appliance, the communication interface is configured to:
communicate a notification that a flood event has occurred.

17. The dishwasher appliance of claim 12, wherein the controller is further configured to:
start a timer upon activating the drain pump;
determine, after the controller activates the drain pump, if the tub lip sensor has sensed wash fluid at or proximate the tub lip for a predetermined time; and
determine whether a current time provided by the timer is less than or equal to a predetermined time threshold if the tub lip sensor has sensed wash fluid at or proximate the tub lip for a predetermined time.

18. The dishwasher appliance of claim 17, wherein after the controller determines whether the current time provided by the timer is less than or equal to the predetermined time threshold, the controller is further configured to:
log a drain fault if the current time provided by the timer is not less than or equal to the predetermined time threshold.
